(19) United States
(12) Patent Application Publication
(10) Pub. No.: US 2021/0099965 A1
(43) Pub. Date: Apr. 1, 2021

(54) CONDITIONS FOR MULTI-ROUND-TRIP-TIME POSITIONING

(71) Applicant: QUALCOMM Incorporated, San Diego, CA (US)

(72) Inventors: Alexandros MANOLAKOS, Escondido, CA (US); Sony AKKARAKARAN, Poway, CA (US); Sven FISCHER, Nuremberg (DE)

(21) Appl. No.: 17/003,801

(22) Filed: Aug. 26, 2020

(30) Foreign Application Priority Data
Sep. 27, 2019 (GR) 20190100421

(51) Int. Cl. H04W 56/00; H04W 64/00; H04L 5/00; H04W 24/10

(52) U.S. Cl. CPC H04W 56/006; H04W 64/003; H04W 56/009; H04W 56/0045; H04W 24/10; H04L 5/0051

(57) ABSTRACT

Disclosed are techniques for wireless communication. In an aspect, a user equipment (UE) receives, from a location server, identifiers of a set of transmission-reception points (TRPs), the set of TRPs including a first reference TRP and a plurality of neighboring TRPs, receives a configuration to report reference signal time difference (RSTD) measurements for the plurality of neighboring TRPs with respect to a receive time of a reference signal from the first reference TRP and UE reception-to-transmission (UE Rx-Tx) measurements for a second reference TRP and the plurality of neighboring TRPs, and transmits, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

### CROSS-REFERENCE TO RELATED APPLICATION

The present Application for Patent claims priority under 35 U.S.C. § 119 to Greek Patent Application No. 20190100421, entitled “CONDITIONS FOR MULTI-ROUND-TRIP-TIME POSITIONING,” filed Sep. 27, 2019, assigned to the assignee hereof, and expressly incorporated herein by reference in its entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G networks), a third-generation (3G) high speed data, Internet-capable wireless service and a fourth-generation (4G) service (e.g., LTE or WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second (gps) to tens of workers on an office floor. Several hundreds of thousands of simultaneous connections should be supported in order to support large wireless deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes receiving, from a location server, identifiers of a set of transmission-reception points (TRPs), the set of TRPs including a first reference TRP and a plurality of neighboring TRPs; receiving, from the location server, a configuration to report reference signal time difference (RSTD) measurements for the plurality of neighboring TRPs with respect to a receive time of a reference signal from the first reference TRP and UE reception-to-transmission (UE Rx-Tx) measurements for a second reference TRP and the plurality of neighboring TRPs; and transmitting, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

In an aspect, a method of wireless communication performed by a location server includes transmitting, to a UE, identifiers of a set of TRPs, the set of TRPs including a first reference TRP and a plurality of neighboring TRPs; transmitting, to the UE, a configuration to report RSTD measurements for the plurality of neighboring TRPs with respect to a receive time of a reference signal from the first reference TRP and UE Rx-Tx measurements for a second reference TRP and the plurality of neighboring TRPs; and receiving, from the UE, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

In an aspect, a UE includes memory; at least one transceiver; and at least one processor communicatively coupled to the memory and the at least one transceiver, the at least one processor configured to: receive, from a location server via the at least one transceiver, identifiers of a set of TRPs, the set of TRPs including a first reference TRP and a plurality of neighboring TRPs; receive, from the location server via the at least one transceiver, a configuration to report RSTD measurements for the plurality of neighboring TRPs with respect to a receive time of a reference signal from the first reference TRP and UE Rx-Tx measurements for a second reference TRP and the plurality of neighboring TRPs; and cause the at least one transceiver to transmit, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

In an aspect, a location server includes memory ; at least one network interface; and at least one processor communicatively coupled to the memory and the at least one network interface, the at least one processor configured to: cause the at least one network interface to transmit, to a UE, identifiers of a set of TRPs, the set of TRPs including a first reference TRP and a plurality of neighboring TRPs; cause the at least one network interface to transmit, to the UE, a configuration to report RSTD measurements for the plurality of neighboring TRPs with respect to a receive time of a reference signal from the first reference TRP and UE Rx-Tx measurements for a second reference TRP and the plurality of neighboring TRPs; and receive, from the UE via the at least one network interface, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

In an aspect, a UE includes means for receiving, from a location server, identifiers of a set of TRPs, the set of TRPs including a first reference TRP and a plurality of neighboring TRPs; means for receiving, from the location server, a configuration to report RSTD measurements for the plurality of neighboring TRPs with respect to a receive time of a reference signal from the first reference TRP and UE Rx-Tx measurements for a second reference TRP and the plurality of neighboring TRPs; and means for transmitting, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

In an aspect, a location server includes means for transmitting, to a UE, identifiers of a set of TRPs, the set of TRPs including a first reference TRP and a plurality of neighboring TRPs; means for transmitting, to the UE, a configuration to report RSTD measurements for the plurality of neighboring TRPs with respect to a receive time of a reference signal from the first reference TRP and UE Rx-Tx measurements for a second reference TRP and the plurality of neighboring TRPs; and means for receiving, from the UE, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

In an aspect, a non-transitory computer-readable medium includes computer-executable instructions, the computer-executable instructions including at least one instruction instructing a UE to receive, from a location server, identifiers of a set of TRPs, the set of TRPs including a first reference TRP and a plurality of neighboring TRPs; at least one instruction instructing the UE to receive, from the location server, a configuration to report RSTD measurements for the plurality of neighboring TRPs with respect to a receive time of a reference signal from the first reference TRP and UE Rx-Tx measurements for a second reference TRP and the plurality of neighboring TRPs; and at least one instruction instructing the UE to transmit, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

In an aspect, a non-transitory computer-readable medium includes computer-executable instructions, the computer-executable instructions including at least one instruction instructing a location server to transmit, to a UE, identifiers of a set of TRPs, the set of TRPs including a first reference TRP and a plurality of neighboring TRPs; at least one instruction instructing the location server to transmit, to the UE, a configuration to report RSTD measurements for the plurality of neighboring TRPs with respect to a receive time of a reference signal from the first reference TRP and UE Rx-Tx measurements for a second reference TRP and the plurality of neighboring TRPs; and at least one instruction instructing the location server to receive, from the UE, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to various aspects.

FIGS. 2A and 2B illustrate example wireless network structures, according to various aspects.

FIGS. 3A to 3C are simplified block diagrams of several sample aspects of components that may be employed in a UE, a base station, and a network entity, respectively.

FIGS. 4A to 4D are diagrams illustrating example frame structures and channels within the frame structures, according to aspects of the disclosure.

FIG. 5 is a diagram illustrating an example technique for determining a position of a UE using information obtained from a plurality of base stations.

FIG. 6 is a diagram showing example timings of round-trip-time (RTT) measurement signals exchanged between a base station and a UE, according to aspects of the disclosure.

FIG. 7 is a diagram showing example timings of RTT measurement signals exchanged between two base stations and a UE, according to aspects of the disclosure.

FIGS. 8 and 9 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference RF signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

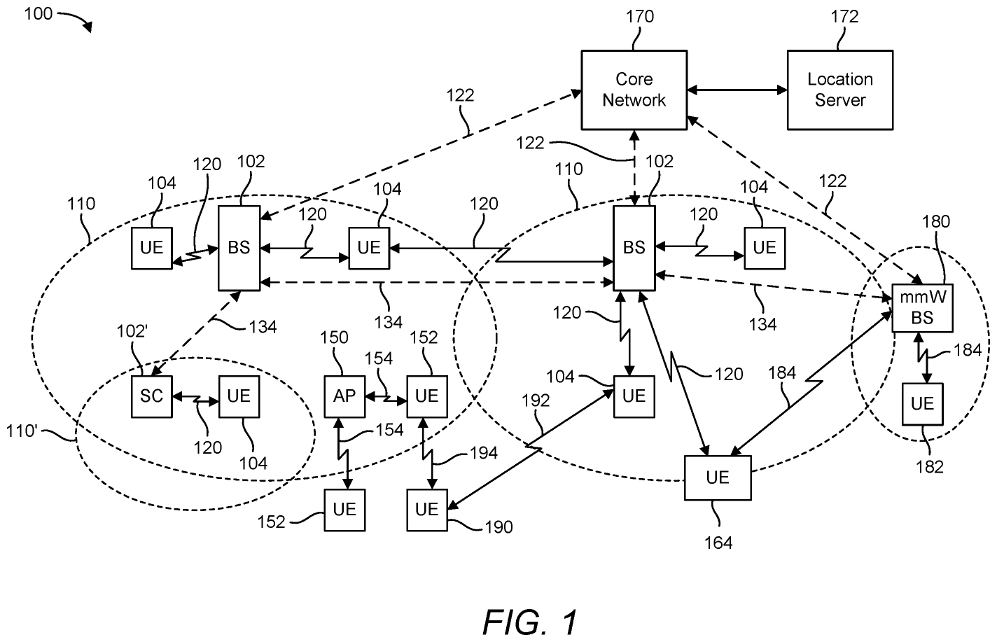

According to various aspects, FIG. 1 illustrates an example wireless communications system 100. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive a reference downlink reference signal (e.g., SSB) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

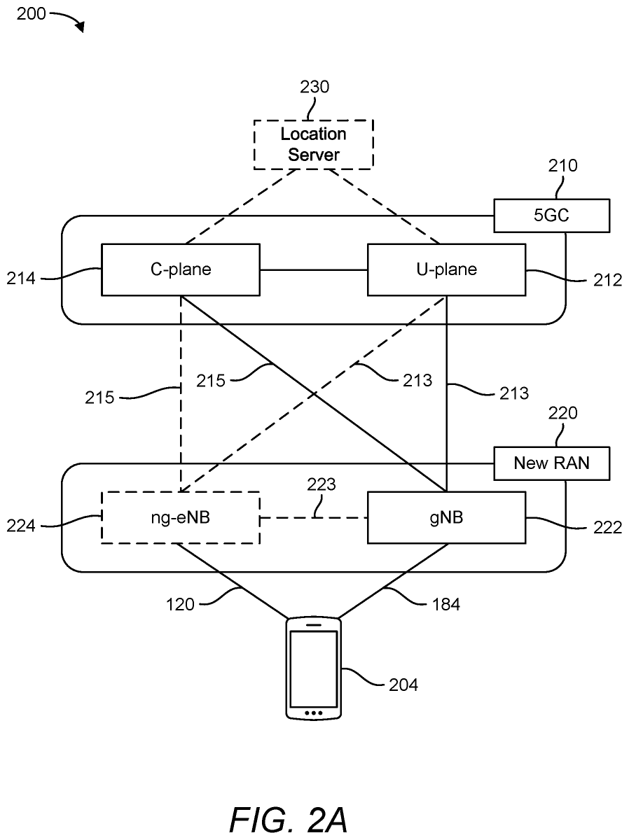

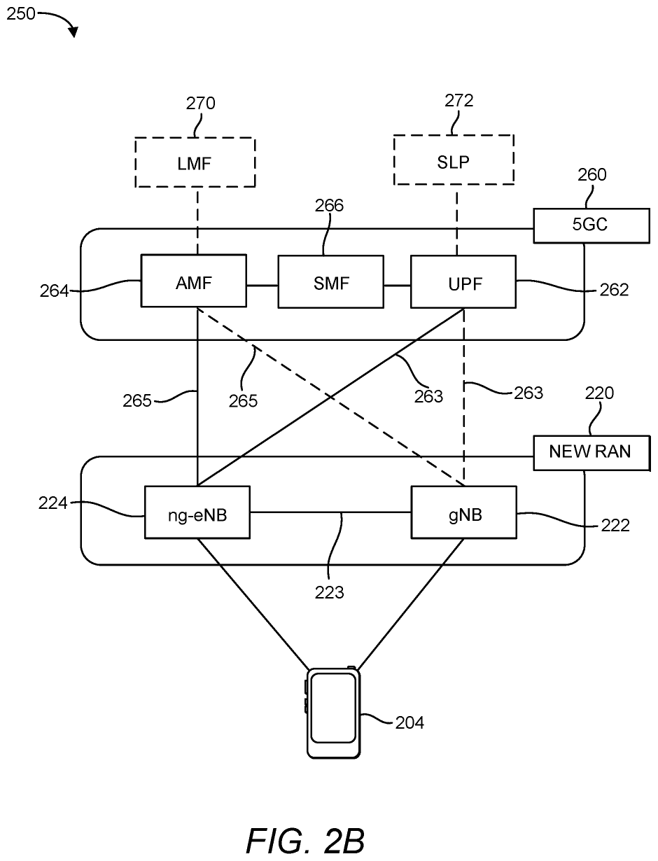

According to various aspects, FIG. 2A illustrates an example wireless network structure 200. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network.

According to various aspects, FIG. 2B illustrates another example wireless network structure 250. For example, a 5GC 260 can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the New RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 also supports functionalities for non-3GPP access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., UL/DL rate enforcement, reflective QoS marking in the DL), UL traffic verification (service data flow (SDF) to QoS flow mapping), transport level packet marking in the UL and DL, DL packet buffering and DL data notification triggering, and sending and forwarding of one or more “end markers” to the source RAN node. The UPF 262 may also support transfer of location services messages over a user plane between the UE 204 and a location server, such as a secure user plane location (SUPL) location platform (SLP) 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

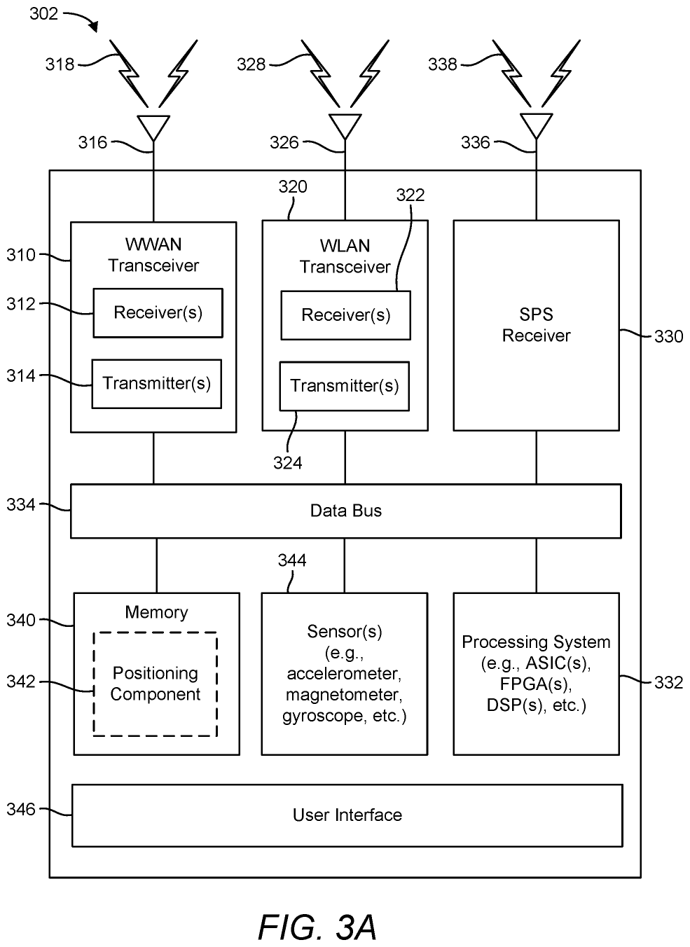

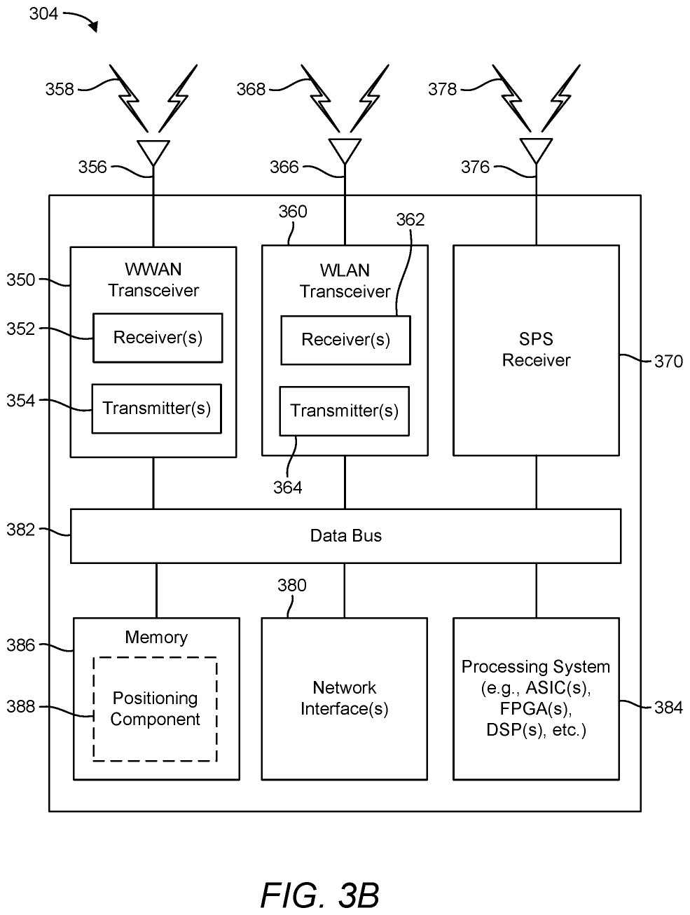

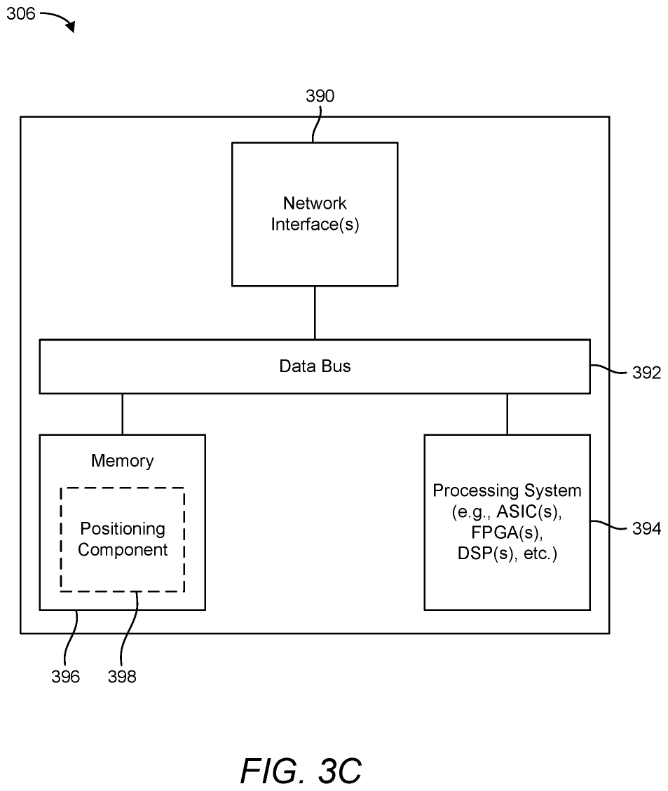

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230, the LMF 270, and the SLP 272) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include wireless wide area network (WWAN) transceiver 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., ng-eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 also include, at least in some cases, wireless local area network (WLAN) transceivers 320 and 360, respectively. The WLAN transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, etc.) over a wireless communication medium of interest. The WLAN transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively.

Transceiver circuitry including at least one transmitter and at least one receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 326, 356, 366), such as an antenna array, that permits the respective apparatus to perform transmit “beamforming,” as described herein. Similarly, a receiver may include or be coupled to a plurality of antennas (e.g., antennas 316, 326, 356, 366), such as an antenna array, that permits the respective apparatus to perform receive beamforming, as described herein. In an aspect, the transmitter and receiver may share the same plurality of antennas (e.g., antennas 316, 326, 356, 366), such that the respective apparatus can only receive or transmit at a given time, not both at the same time. A wireless communication device (e.g., one or both of the transceivers 310 and 320 and/or 350 and 360) of the UE 302 and/or the base station 304 may also comprise a network listen module (NLM) or the like for performing various measurements.

The UE 302 and the base station 304 also include, at least in some cases, satellite positioning systems (SPS) receivers 330 and 370. The SPS receivers 330 and 370 may be connected to one or more antennas 336 and 376, respectively, and may provide means for receiving and/or measuring SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and performs calculations necessary to determine positions of the UE 302 and the base station 304 using measurements obtained by any suitable SPS algorithm.

The base station 304 and the network entity 306 each include at least one network interfaces 380 and 390, respectively, providing means for communicating (e.g., means for transmitting, means for receiving, etc.) with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving messages, parameters, and/or other types of information.

The UE 302, the base station 304, and the network entity 306 also include other components that may be used in conjunction with the operations as disclosed herein. The UE 302 includes processor circuitry implementing a processing system 332 for providing functionality relating to, for example, positioning operations, and for providing other processing functionality. The base station 304 includes a processing system 384 for providing functionality relating to, for example, positioning operations as disclosed herein, and for providing other processing functionality. The network entity 306 includes a processing system 394 for providing functionality relating to, for example, positioning operations as disclosed herein, and for providing other processing functionality. The processing systems 332, 384, and 394 may therefore provide means for processing, such as means for determining, means for calculating, means for receiving, means for transmitting, means for indicating, etc. In an aspect, the processing systems 332, 384, and 394 may include, for example, one or more general purpose processors, multi-core processors, ASICs, digital signal processors (DSPs), field programmable gate arrays (FPGA), or other programmable logic devices or processing circuitry.

The UE 302, the base station 304, and the network entity 306 include memory circuitry implementing memory components 340, 386, and 396 (e.g., each including a memory device), respectively, for maintaining information (e.g., information indicative of reserved resources, thresholds, parameters, and so on). The memory components 340, 386, and 396 may therefore provide means for storing, means for retrieving, means for maintaining, etc. In some cases, the UE 302, the base station 304, and the network entity 306 may include positioning components 342, 388, and 398, respectively. The positioning components 342, 388, and 398 may be hardware circuits that are part of or coupled to the processing systems 332, 384, and 394, respectively, that, when executed, cause the UE 302, the base station 304, and the network entity 306 to perform the functionality described herein. In other aspects, the positioning components 342, 388, and 398 may be external to the processing systems 332, 384, and 394 (e.g., part of a modem processing system, integrated with another processing system, etc.). Alternatively, the positioning components 342, 388, and 398 may be memory modules (as shown in FIGS. 3A-C) stored in the memory components 340, 386, and 396, respectively, that, when executed by the processing systems 332, 384, and 394 (or a modem processing system, another processing system, etc.), cause the UE 302, the base station 304, and the network entity 306 to perform the functionality described herein.

The UE 302 may include one or more sensors 344 coupled to the processing system 332 to provide means for sensing or detecting movement and/or orientation information that is independent of motion data derived from signals received by the WWAN transceiver 310, the WLAN transceiver 320, and/or the SPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in 2D and/or 3D coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the processing system 384 in more detail, in the downlink, IP packets from the network entity 306 may be provided to the processing system 384. The processing system 384 may implement functionality for an RRC layer, a packet data convergence protocol (PDCP) layer, a radio link control (RLC) layer, and a medium access control (MAC) layer. The processing system 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the processing system 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 and Layer-2 functionality.

In the UL, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the DL transmission by the base station 304, the processing system 332 provides RRC layer functionality associated with system information (e.g., MIB, SIBS) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The UL transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the processing system 384.

In the UL, the processing system 384 provides demultiplexing between transport and logical channels, packet reassembly, deciphering, header decompression, control signal processing to recover IP packets from the UE 302. IP packets from the processing system 384 may be provided to the core network. The processing system 384 is also responsible for error detection.

For convenience, the UE 302, the base station 304, and/or the network entity 306 are shown in FIGS. 3A-C as including various components that may be configured according to the various examples described herein. It will be appreciated, however, that the illustrated blocks may have different functionality in different designs.

The various components of the UE 302, the base station 304, and the network entity 306 may communicate with each other over data buses 334, 382, and 392, respectively. The components of FIGS. 3A-C may be implemented in various ways. In some implementations, the components of FIGS. 3A-C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a positioning entity,” etc. However, as will be appreciated, such operations, acts, and/or functions may actually be performed by specific components or combinations of components of the UE, base station, positioning entity, etc., such as the processing systems 332, 384, 394, the transceivers 310, 320, 350, and 360, the memory components 340, 386, and 396, the positioning components 342, 388, and 398, etc.

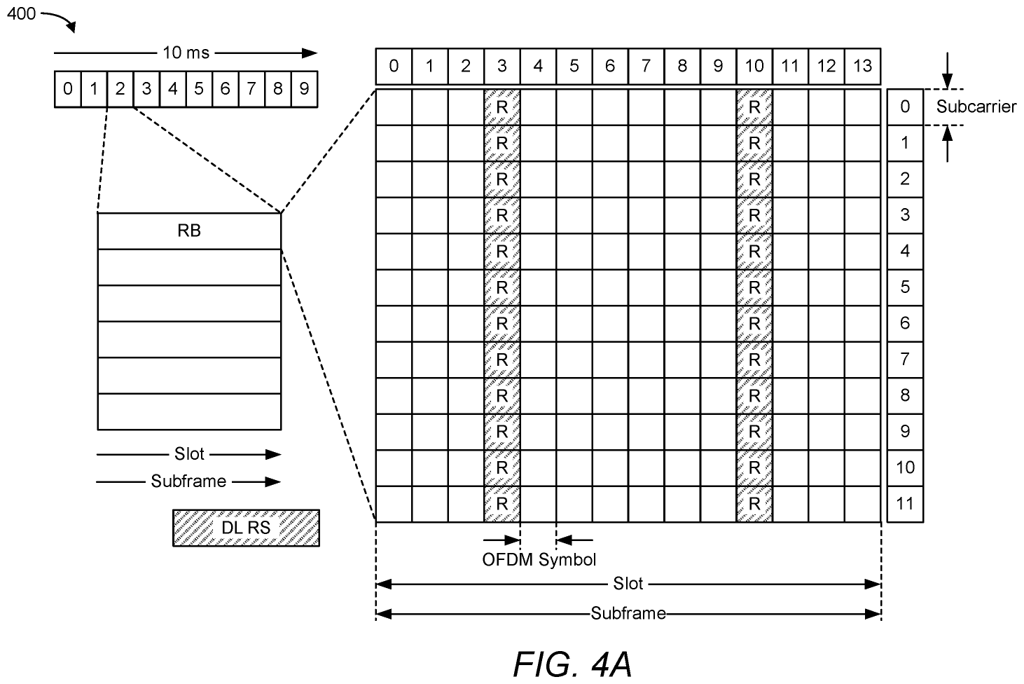

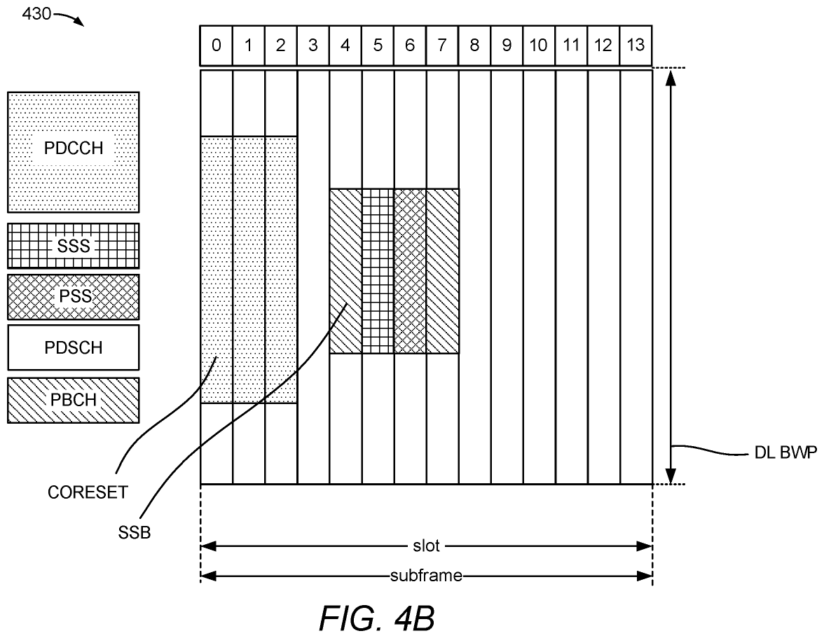

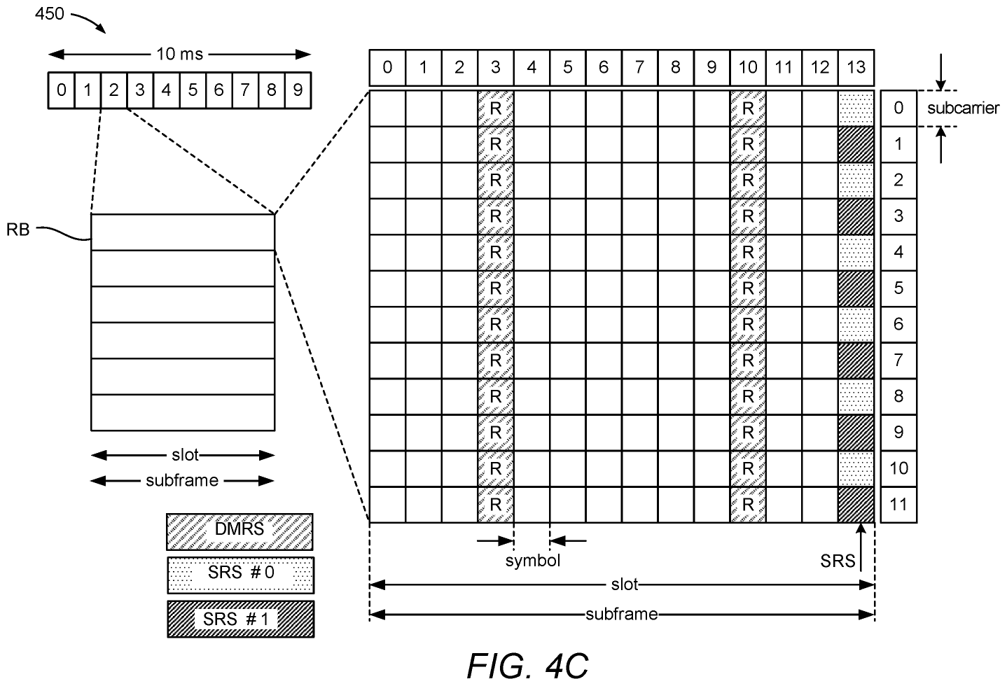

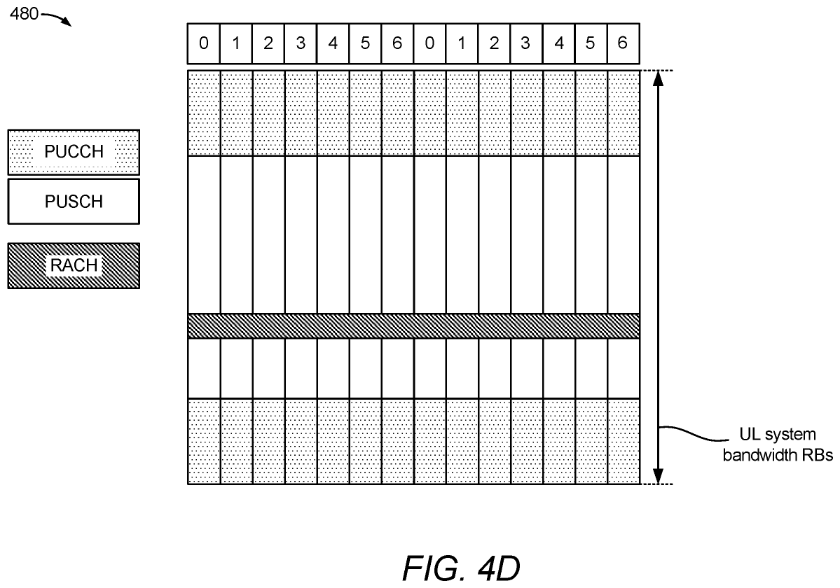

Various frame structures may be used to support downlink and uplink transmissions between network nodes (e.g., base stations and UEs). FIG. 4A is a diagram 400 illustrating an example of a downlink frame structure, according to aspects of the disclosure. FIG. 4B is a diagram 430 illustrating an example of channels within the downlink frame structure, according to aspects of the disclosure. FIG. 4C is a diagram 450 illustrating an example of an uplink frame structure, according to aspects of the disclosure. FIG. 4D is a diagram 480 illustrating an example of channels within an uplink frame structure, according to aspects of the disclosure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast, NR may support multiple numerologies (μ), for example, subcarrier spacing of 15 kHz, 30 kHz, 60 kHz, 120 kHz, and 240 kHz or greater may be available. Table 1 provided below lists some various parameters for different NR numerologies.

TABLE 1

| | | | | | | | Max. |
|---|---|---|---|---|---|---|---|
| | | | | | | | nominal |
| | | | | | Slot | Symbol | system BW |
| | SCS | Sym- | Slots/ | Slots/ | Duration | Duration | (MHz) with |
| μ | (kHz) | bols/Sot | Subframe | Frame | (ms) | (μs) | 4K FFT size |
| 0 | 15 | 14 | 1 | 10 | 1 | 66.7 | 50 |
| 1 | 30 | 14 | 2 | 20 | 0.5 | 33.3 | 100 |
| 2 | 60 | 14 | 4 | 40 | 0.25 | 16.7 | 100 |
| 3 | 120 | 14 | 8 | 80 | 0.125 | 8.33 | 400 |
| 4 | 240 | 14 | 16 | 160 | 0.0625 | 4.17 | 800 |

In the example of FIGS. 4A to 4D, a numerology of 15 kHz is used. Thus, in the time domain, a frame (e.g., 10 ms) is divided into 10 equally sized subframes of 1 ms each, and each subframe includes one time slot. In FIGS. 4A to 4D, time is represented horizontally (e.g., on the X axis) with time increasing from left to right, while frequency is represented vertically (e.g., on the Y axis) with frequency increasing (or decreasing) from bottom to top. Note that while FIGS. 4A to 4D illustrate a 10 ms frame with 1 ms slots and subframes, this is only an example, and the disclosure is not so limited.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIGS. 4A to 4D, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

As illustrated in FIG. 4A, some of the REs carry downlink reference (pilot) signals (DL-RS) for channel estimation at the UE. The DL-RS may include demodulation reference signals (DMRS), channel state information reference signals (CSI-RS), cell-specific reference signals (CRS), positioning reference signals (PRS), navigation reference signals (NRS), tracking reference signals (TRS), etc., example locations of which are labeled “R” in FIG. 4A.

A collection of resource elements (REs) that are used for transmission of PRS is referred to as a “PRS resource.” The collection of resource elements can span multiple PRBs in the frequency domain and N (e.g., 1 or more) consecutive symbol(s) within a slot in the time domain. In a given OFDM symbol in the time domain, a PRS resource occupies consecutive PRBs in the frequency domain.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a cell ID). In addition, the PRS resources in a PRS resource set have the same periodicity, a common muting pattern configuration, and the same repetition factor across slots. The periodicity may have a length selected from 2^{m}·{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (and/or beam ID) transmitted from a single TRP (where a TRP may transmit one or more beams). That is, each PRS resource of a PRS resource set may be transmitted on a different beam, and as such, a “PRS resource,” or simply “resource,” can also be referred to as a “beam.” Note that this does not have any implications on whether the TRPs and the beams on which PRS are transmitted are known to the UE.

A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance, a “positioning occasion,” “a positioning instance,” or simply an “occasion” or “instance.”

Note that the terms “positioning reference signal” and “PRS” may sometimes refer to specific reference signals that are used for positioning in LTE systems. However, as used herein, unless otherwise indicated, the terms “positioning reference signal” and “PRS” refer to any type of reference signal that can be used for positioning, such as but not limited to, PRS, NRS, TRS, CRS, CSI-RS, DMRS, PSS, SSS, SSB, etc.

FIG. 4B illustrates an example of various channels within a downlink slot of a radio frame. In NR, the channel bandwidth, or system bandwidth, is divided into multiple bandwidth parts (BWPs). A BWP is a contiguous set of PRBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 4B, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries an MIB, may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 4B, there is one CORESET per BWP, and the CORESET spans three symbols in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 4B is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE. Multiple (e.g., up to eight) DCIs can be configured in the PDCCH, and these DCIs can have one of multiple formats. For example, there are different DCI formats for uplink scheduling, for non-MIMO downlink scheduling, for MIMO downlink scheduling, and for uplink power control. A PDCCH may be transported by 1, 2, 4, 8, or 16 CCEs in order to accommodate different DCI payload sizes or coding rates.

As illustrated in FIG. 4C, some of the REs carry DMRS for channel estimation at the base station. The UE may additionally transmit SRS in, for example, the last symbol of a subframe. The SRS may have a comb structure, and a UE may transmit SRS on one of the combs. The comb structure (also referred to as the “comb size”) indicates the number of subcarriers in each symbol period carrying a reference signal (here, SRS). For example, a comb size of comb-4 means that every fourth subcarrier of a given symbol carries the reference signal, whereas a comb size of comb-2 means that every second subcarrier of a given symbol carries the reference signal. In the example of FIG. 4C, the illustrated SRS are both comb-2. The SRS may be used by a base station to obtain the channel state information (CSI) for each UE. CSI describes how an RF signal propagates from the UE to the base station and represents the combined effect of scattering, fading, and power decay with distance. The system uses the SRS for resource scheduling, link adaptation, massive MIMO, beam management, etc.

FIG. 4D illustrates an example of various channels within an uplink subframe of a frame, according to aspects of the disclosure. A random access channel (RACH), also referred to as a physical random access channel (PRACH), may be within one or more subframes within a frame based on the PRACH configuration. The PRACH may include six consecutive RB pairs within a subframe. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests, CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

A collection of resource elements that are used for transmission of SRS is referred to as an “SRS resource,” and may be identified by the parameter SRS-ResourceId. The collection of resource elements can span multiple PRBs in the frequency domain and N (e.g., one or more) consecutive symbol(s) within a slot in the time domain. In a given OFDM symbol, an SRS resource occupies consecutive PRBs. An “SRS resource set” is a set of SRS resources used for the transmission of SRS signals, and is identified by an SRS resource set ID (SRS-ResourceSetId).

Generally, a UE transmits SRS to enable the receiving base station (either the serving base station or a neighboring base station) to measure the channel quality between the UE and the base station. However, SRS can also be used as uplink positioning reference signals for uplink positioning procedures, such as uplink time-difference of arrival (UL-TDOA), multi-round-trip-time (multi-RTT), angle-of-arrival (AoA), etc.

Several enhancements over the previous definition of SRS have been proposed for SRS-for-positioning, such as a new staggered pattern within an SRS resource (except for single-symbol/comb-2), a new comb type for SRS, new sequences for SRS, a higher number of SRS resource sets per component carrier, and a higher number of SRS resources per component carrier. In addition, the parameters SpatialRelationInfo and PathLossReference are to be configured based on a downlink reference signal or SSB from a neighboring TRP. Further still, one SRS resource may be transmitted outside the active BWP, and one SRS resource may span across multiple component carriers. Also, SRS may be configured in RRC connected state and only transmitted within an active BWP. Further, there may be no frequency hopping, no repetition factor, a single antenna port, and new lengths for SRS (e.g., 8 and 12 symbols). There may also be open-loop power control and not closed-loop power control, and comb-8 (i.e., an SRS transmitted every eighth subcarrier in the same symbol) may be used. Lastly, the UE may transmit through the same transmit beam from multiple SRS resources for UL-AoA. All of these are features that are additional to the current SRS framework, which is configured through RRC higher layer signaling (and potentially triggered or activated through MAC control element (CE) or DCI).

In 5G NR, there may not be precise timing synchronization across the network. Instead, it may be sufficient to have coarse time-synchronization across gNBs (e.g., within a cyclic prefix (CP) duration of the OFDM symbols). RTT-based methods generally only need coarse timing synchronization, and as such, are a preferred positioning method in NR.

In a network-centric RTT estimation, the serving base station instructs the UE to scan for/receive the RTT measurement signals from two or more neighboring base stations (and typically the serving base station, as at least three base stations are needed). The one or more base stations transmit RTT measurement signals on low reuse resources (i.e., resources used by the base station to transmit system information) allocated by the network (e.g., location server 230, LMF 270, SLP 272). The UE records the arrival time (also referred to as the receive time, reception time, time of reception, or time of arrival) of each RTT measurement signal relative to the UE's current downlink timing (e.g., as derived by the UE from a downlink signal received from its serving base station), and transmits a common or individual RTT response message to the involved base stations (e.g., when instructed by its serving base station), and may include each of the measured arrival times in a payload of the RTT response message(s).

A UE-centric RTT estimation is similar to the network-based method, except that the UE transmits uplink RTT measurement signal(s) (e.g., when instructed by a serving base station or location server), which are received by multiple base stations in the neighborhood of the UE. Each involved base station responds with a downlink RTT response message, which may include the arrival time of the RTT measurement signal at the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response messages or signals that may include the arrival (or receive) time(s) of the first message(s) or signal(s) in the RTT response message payload.

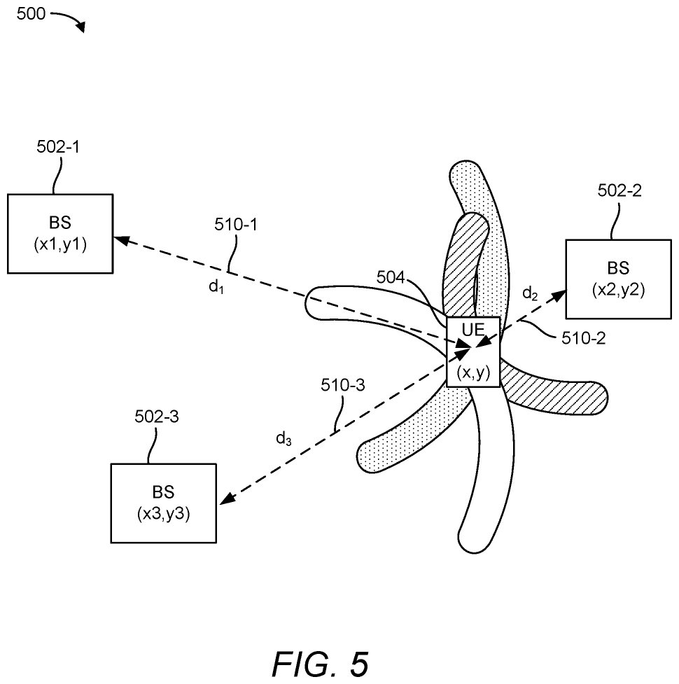

FIG. 5 illustrates an example wireless communications system 500 according to aspects of the disclosure. In the example of FIG. 5, a UE 504 (which may correspond to any of the UEs described herein) is attempting to calculate an estimate of its location, or assist another entity (e.g., a base station or core network component, another UE, a location server, a third party application, etc.) to calculate an estimate of its location. The UE 504 may communicate wirelessly with a plurality of base stations (BS) 502-1, 502-2, and 502-3 (collectively, base stations 502, and which may correspond to any of the base stations described herein) using RF signals and standardized protocols for the modulation of the RF signals and the exchange of information packets. By extracting different types of information from the exchanged signals, and utilizing the layout of the wireless communications system 500 (i.e., the base stations' locations, geometry, etc.), the UE 504 may determine its location, or assist in the determination of its location, in a predefined reference coordinate system. In an aspect, the UE 504 may specify its location using a two-dimensional coordinate system; however, the aspects disclosed herein are not so limited, and may also be applicable to determining locations using a three-dimensional coordinate system, if the extra dimension is desired. Additionally, while FIG. 5 illustrates one UE 504 and three base stations 502, as will be appreciated, there may be more UEs 504 and more base stations 502.

To support location estimates, the base stations 502 may be configured to broadcast reference RF signals (e.g., PRS, NRS, CRS, TRS, CSI-RS, SSB, PSS, SSS, etc.) to UEs 504 in their coverage area to enable a UE 504 to measure characteristics of such reference signals. For example, the UE 504 may measure the time of arrival (ToA) of specific reference signals (e.g., PRS, NRS, CRS, CSI-RS, etc.) transmitted by at least three different base stations 502-1, 502-2, and 502-3 and may use the RTT positioning method to report these ToAs (and additional information) back to the serving base station 502 or another positioning entity (e.g., location server 230, LMF 270, SLP 272).

In an aspect, although described as the UE 504 measuring reference signals from a base station 502, the UE 504 may measure reference signals from one of multiple cells or TRPs supported by a base station 502. Where the UE 504 measures reference signals transmitted by a cell/TRP supported by a base station 502, the at least two other reference signals measured by the UE 504 to perform the RTT procedure would be from cells/TRPs supported by base stations 502 different from the first base station 502 and may have good or poor signal strength at the UE 504.

In order to determine the location (x, y) of the UE 504, the entity determining the location of the UE 504 needs to know the locations of the base stations 502, which may be represented in a reference coordinate system as (xₖ, yₖ), where k=1, 2, 3 in the example of FIG. 5. Where one of the base stations 502 (e.g., the serving base station) or the UE 504 determines the location of the UE 504, the locations of the involved base stations 502 may be provided to the serving base station 502 or the UE 504 by a location server with knowledge of the network geometry (e.g., location server 230, LMF 270, SLP 272). Alternatively, the location server may determine the location of the UE 504 using the known network geometry.

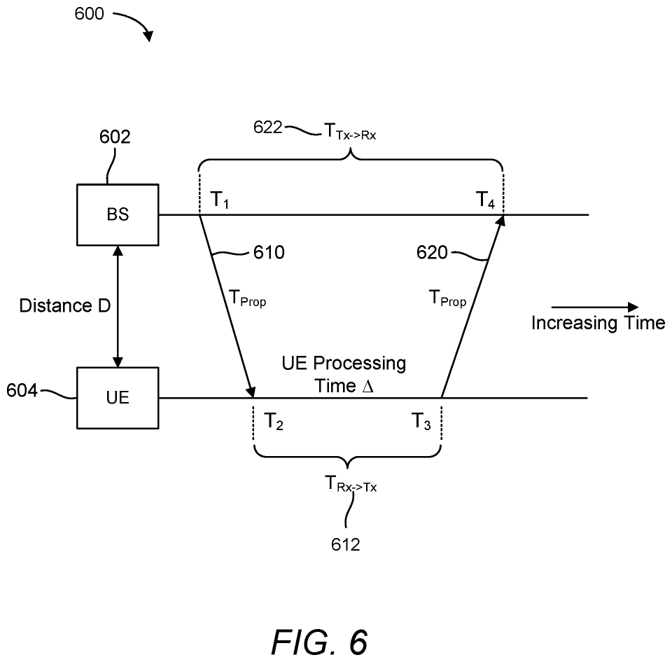

Either the UE 504 or the respective base station 502 may determine the distance 510 (dₖ, where k=1, 2, 3) between the UE 504 and the respective base station 502. Specifically, in the example of FIG. 5, the distance 510-1 between the UE 504 and the base station 502-1 is d₁, the distance 510-2 between the UE 504 and the base station 502-2 is d₂, and the distance 510-3 between the UE 504 and the base station 502-3 is d₃. In an aspect, determining the RTT of the RF signals exchanged between the UE 504 and any base station 502 can be performed and converted to a distance 510 (dₖ). As discussed further below with reference to FIG. 6, RTT techniques can measure the time between sending an RTT measurement signal and receiving an RTT response signal. These methods may utilize calibration to remove any processing delays. In some environments, it may be assumed that the processing delays for the UE 504 and the base stations 502 are the same. However, such an assumption may not be true in practice.

Once each distance 510 is determined, the UE 504, a base station 502, or the location server (e.g., location server 230, LMF 270, SLP 272) can solve for the location (x, y) of the UE 504 by using a variety of known geometric techniques, such as, for example, trilateration. From FIG. 5, it can be seen that the location of the UE 504 ideally lies at the common intersection of three semicircles, each semicircle being defined by radius dₖ and center (xₖ, yₖ), where k=1, 2, 3.

A location estimate (e.g., for a UE 504) may be referred to by other names, such as a position estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

FIG. 6 is a diagram 600 showing example timings of RTT measurement signals exchanged between a base station 602 (e.g., any of the base stations described herein) and a UE 604 (e.g., any of the UEs described herein), according to aspects of the disclosure. In the example of FIG. 6A, the base station 602 sends an RTT measurement signal 610 (e.g., PRS, NRS, CRS, CSI-RS, etc.) to the UE 604 at time T₁. The RTT measurement signal 610 has some propagation delay T_{Prop} as it travels from the base station 602 to the UE 604. At time T₂ (the ToA of the RTT measurement signal 610 at the UE 604), the UE 604 receives/measures the RTT measurement signal 610. After some UE processing time, the UE 604 transmits an RTT response signal 620 (e.g., an SRS, UL-PRS, DMRS, etc.) at time T₃. After the propagation delay T_{Prop}, the base station 602 receives/measures the RTT response signal 620 from the UE 604 at time T₄ (the ToA of the RTT response signal 620 at the base station 602).

In order to identify the ToA (e.g., T₂) of an RF signal (e.g., an RTT measurement signal 610) transmitted by a given network node, the receiver (e.g., UE 604) first jointly processes all the resource elements (REs) on the channel on which the transmitter (e.g., base station 602) is transmitting the RF signal, and performs an inverse Fourier transform to convert the received RF signals to the time domain. The conversion of the received RF signals to the time domain is referred to as estimation of the channel energy response (CER). The CER shows the peaks on the channel over time, and the earliest “significant” peak should therefore correspond to the ToA of the RF signal. Generally, the receiver will use a noise-related quality threshold to filter out spurious local peaks, thereby presumably correctly identifying significant peaks on the channel. For example, the UE 604 may choose a ToA estimate that is the earliest local maximum of the CER that is at least X decibels (dB) higher than the median of the CER and a maximum Y dB lower than the main peak on the channel. The receiver determines the CER for each RF signal from each transmitter in order to determine the ToA of each RF signal from the different transmitters.

The RTT response signal 620 may explicitly include the difference between time T₃ and time T₂ (i.e., T_{Rx→Tx} 612), referred to as the “UE Rx-Tx” measurement. Alternatively, it may be derived from the timing advance (TA), i.e., the relative UL/DL frame timing and specification location of uplink reference signals. (Note that the TA is usually the RTT between the base station 602 and the UE 604, or double the propagation time in one direction.) Using this measurement and the difference between time T₄ and time T₁ (i.e., T_{Tx→Rx} 622), referred to as the “BS Tx-Rx” measurement, the base station 602 can calculate the distance to the UE 604 as:

$$d = \frac{1}{2 c} ( {T}_{Tx \to Rx} - {T}_{Rx \to Tx} ) = \frac{1}{2 c} ( {T}_{4} - {T}_{1} ) - \frac{1}{2 c} ( {T}_{3} - {T}_{2} ) ,$$

where c is the speed of light.

As illustrated in FIG. 5, the UE 604 can perform an RTT procedure with multiple base stations 602, referred to as “multi-RTT” or “multi-cell RTT.” However, such an RTT procedure does not require synchronization between the involved base stations 602.

For multi-cell RTT positioning in NR, the UE reports the UE Rx-Tx measurement (e.g., T_{Rx→Tx} 612) for both the serving and neighboring base stations (or more specifically, the serving and neighboring cells/TRPs). Similarly, each base station reports the BS Tx-Rx measurement (e.g., T_{Tx→Rx} 622) for each UE. As a specific example, assume that for a first base station “gNB1,” the UE receives a first RTT measurement signal “PRS1” (e.g., RTT measurement signal 610), transmits a first RTT response signal “SRS1” (e.g., RTT response signal 620), and reports the time difference between the reception of PRS1 and the transmission of SRS1 (referred to in this example as “UERx₁−UETx₁”). The UE also receives, from a second base station “gNB2,” a second RTT measurement signal “PRS2,” transmits a second RTT response signal “SRS2,” and reports the time difference between the reception of PRS2 and the transmission of SRS2 (referred to in this example as “UERx₂−UETx₂”).

The first base station gNB1 transmits PRS1, receives SRS1, and reports the time difference between the transmission of PRS1 and the reception of SRS1 (referred to in this example as “gNBRx₁−gNBTx₁”). The second base station gNB2 transmits PS2, receives SRS2, and reports the time difference between the transmission of PRS2 and the reception of SRS2 (referred to in this example as “gNBRx₂−gNBTx₂”). With this information, the location server (e.g., location server 230, LMF 270, SLP 272) can derive the RTTs between the UE and the base stations gNB1 and gNB2 as follows:

RTT₁=UERx₁−UETx₁+gNBRx₁−gNBTx₁

RTT₂=UERx₂−UETx₂+gNBRx₂−gNBTx₂

In some cases, the number of measurements that the UE needs to report to the location server can be reduced, thereby reducing signaling overhead. For example, assume that the UE transmitted SRS1 and SRS2 at the same time, or that there was only one SRS transmitted for both base stations gNB1 and gNB2 (i.e., SRS1=SRS2). In that case, UETx₁=UETx₂, and the UE Rx-Tx measurement for gNB2 (i.e., UERx₂−UETx₂) can be re-written as:

$$\begin{matrix}{UERx}_{2} - {UETx}_{2} = {UERx}_{2} - {UETx}_{1} + ( {UERx}_{1} - {UERx}_{1} ) \\ = ( {UERx}_{2} - {UERx}_{1} ) + ( {UERx}_{1} - {UETx}_{1} )\end{matrix}$$

Thus, instead of reporting the UE Rx-Tx measurement for base station gNB2 (i.e., UERx₂−UETx₂), the UE can simply report the reference signal time difference (RSTD) measurement between base stations gNB1 and gNB2 (i.e., UERx₂−UERx₁). Similarly, for any additional base station(s), the UE only needs to report the RSTD measurement between base station gNB1 and the additional base station(s). For the reference base station, here base station gNB1, the UE still reports the UE Rx-Tx measurement (i.e., UERx₁−UETx₁).

The location server can use the RSTD measurement for base station gNB2 (i.e., UERx₂−UERx₁) and the UE Rx-Tx measurement for base station gNB1 (i.e., UERx₁−UETx₁) to derive the UE Rx-Tx measurement for base station gNB2 (i.e., UERx₂−UETx₂). Using the BS Rx-Tx measurements from both base stations gNB1 and gNB2, the UE Rx-Tx measurement for base station gNB1 (i.e., UERx₁−UETx₁), and the derived UE Rx-Tx measurement for base station gNB2 (i.e., UERx₂−UETx₂), the location server can derive the RTT between the UE and the base station gNB1 (i.e., RTT₁) and the RTT between the UE and the base station gNB2 (i.e., RTT₂), as shown above.

The above technique of reporting only the RSTD measurements for non-reference base stations can save signaling overhead (e.g., fewer LTE positioning protocol (LPP) messages) if the UE is already reporting RSTD measurements, for example, for an observed time difference of arrival (OTDOA) positioning procedure. The assumptions made in the above analysis are that the RTT response signals SRS1 and SRS2 transmitted towards all involved base stations have the same timing (e.g., same transmission time), and the reference base station for the RSTD report is the serving base station. There is no assumption, however, that the base stations need to be synchronized. In addition, it should be observed that each base station performs BS Tx-Rx measurements, which means that the same number of measurements needs to be taken by both the UE and the base stations.

The assumption that the timing of the RTT response signal is the same for different base stations may not hold in practice. For example, different path-loss references and spatial transmit beams may be configured for different RTT response signal resources (the latter is more related to FR2 operation). In addition, different RTT response signals may be transmitted towards different base stations, and these RTT response signal occasions may be time-division multiplexed (potentially on different slots or different frames). Further, some differences in timing are expected (e.g., autonomous transmission adjustments, beam-specific differences, jitter across different RTT response signal transmissions), and precise positioning would not be possible, or additional UE requirements may be enforced for the UE.

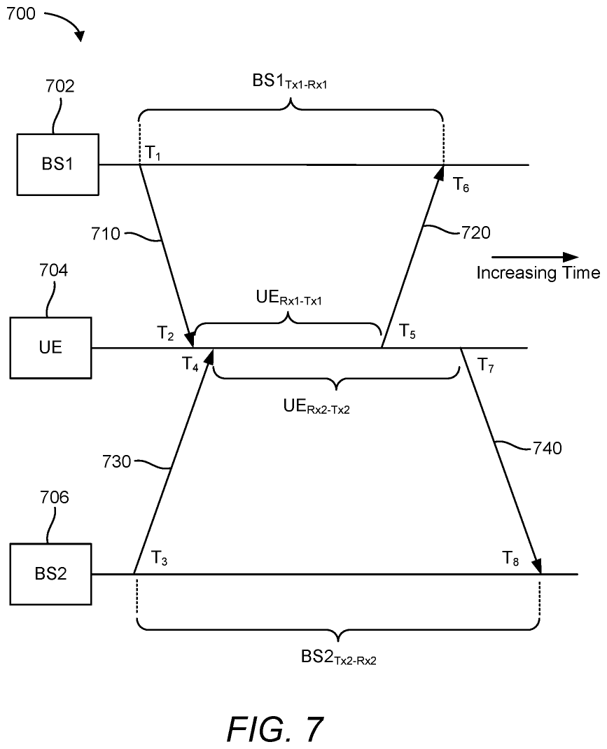

This difference in timing is illustrated in FIG. 7. FIG. 7 is a diagram 700 showing example timings of RTT measurement signals exchanged between a UE 704 (e.g., any of the UEs described herein) and two base stations 702 and 706 (e.g., any of the base stations described herein, and more specifically, TRPs of any of the base stations described herein), according to aspects of the disclosure. As shown in FIG. 7, the first base station 702 (labelled “BS1”) transmits a first RTT measurement signal 710 at time T₁, and at time T₃, the second base station 706 (labelled “BS2”) transmits a second RTT measurement signal 730. The UE 704 receives the first RTT measurement signal 710 at time T₂ and the second RTT measurement signal 730 at time T₄. At time T₅, the UE 704 transmits a first RTT response signal 720, which is received at the first base station 702 at time T₆, and at time T₇, transmits a second RTT response signal 740, which is received at the second base station 706 at time T₈. As illustrated in FIG. 7, the UE 704 does not transmit the RTT response signals 720 and 740 at the same time.

In some cases, it may be beneficial to report both the UE Rx-Tx measurement and the RSTD measurement for neighboring base stations, such as in the case of UE-assisted network synchronization. That is, where the involved base stations are not synchronized, the UE Rx-Tx and RSTD measurements associated with the involved base stations can be used to synchronize them. As another example, the UE may use a reference base station that is different than the serving base station, in which case, the above solution may not work unless the UE also provided the UE Rx-Tx measurement of the reference base station used in the RSTD measurement derivations.

Accordingly, the present disclosure provides conditions under which a UE can refrain from reporting UE Rx-Tx measurements in a multi-RTT-based positioning procedure. Specifically, for a UE configured to report, in the same LPP measurement session for the same set of TRPs (some of which may be associated with the same base station or all of which may be associated with different base stations), both (a) an RSTD vector (i.e., RSTD measurements for neighboring TRPs with respect to a reference TRP) and (b) UE Rx-Tx measurements for serving and neighboring TRPs, the UE may report just one (a single) UE Rx-Tx measurement for the reference TRP and a collection of RSTD measurements for the neighboring TRPs with respect to the reference TRP (more specifically, the receive time of a reference signal received from the reference TRP) only if one or more of the following conditions are met. The location server may configure the UE to report both the RSTD vector and the UE Rx-Tx measurements in the same LPP measurement session for the same set of TRPs. This may occur in the case of the UE performing both an RTT positioning procedure and an OTDOA positioning procedure.

As a first condition, the UE may report just the UE Rx-Tx measurement for the reference TRP and the collection of RSTD measurements for the neighboring TRPs only if the UE is configured to transmit one uplink PRS resource (e.g., one SRS resource) towards all the involved TRPs (i.e., both the reference and neighboring TRPs).

As a second condition, the UE may report just the UE Rx-Tx measurement for the reference TRP and the collection of RSTD measurements for the neighboring TRPs only if the UE is configured to transmit with multiple uplink PRS resources and (a) all of the uplink PRS resources have the same timing, (b) the UE is not expected to perform an autonomous timing advance (TA) adjustment, and (c) the UE does not expect to receive a TA command during one span of the uplink PRS transmission occasions. A span of uplink PRS transmission occasions is a plurality of uplink PRS transmission occasions within some number of slots “X,” where X is a reported UE capability.

As a third condition, the UE may report just the UE Rx-Tx measurement for the reference TRP and the collection of RSTD measurements for the neighboring TRPs only if the UE is configured to transmit with multiple uplink PRS resources, all of which have the same reference as the spatial transmit reference resource (if applicable), or there is up to one spatial transmit reference resource configured (if applicable) across all the uplink PRS resources.

As a fourth condition, the UE may report just the UE Rx-Tx measurement for the reference TRP and the collection of RSTD measurements for the neighboring TRPs only if the reference TRP is the serving TRP of the UE.

As a fifth condition, the UE may report just the UE Rx-Tx measurement for the reference TRP and the collection of RSTD measurements for the neighboring TRPs only if the UE has been configured to perform this overhead reduction technique. For example, there may be an LPP configuration that turns on or off the skipping of the UE Rx-Tx reports.

As a sixth condition, the UE may report just the UE Rx-Tx measurement for the reference TRP and the collection of RSTD measurements for the neighboring TRPs only if the timestamps of the measurements (e.g., the slots, subframes, and/or frames during which the measurements are valid) is the same.

If one or more of the above conditions are met, the UE may report just the UE Rx-Tx measurement for the reference TRP and the collection of RSTD measurements for the neighboring TRPs. These conditions may be preconfigured at the UE by an original equipment manufacturer (OEM) based on the applicable cellular standard. The location server will be aware of the UE being configured with these conditions, and will expect the UE to report accordingly. Thus, when the location server knows that one or more of the conditions have been met, it will expect any measurement report received from the UE to include only the UE Rx-Tx measurement for the reference TRP and a collection of RSTD measurements for the neighboring TRPs.

In some cases, the above-described conditions can be relaxed. For example, rather than requiring the timestamps of the measurements to be the same (the sixth condition), they can instead be within some threshold or range. However, as this will impact the measurement accuracy, the location server will need to relax the expected accuracy of the resultant position estimate.

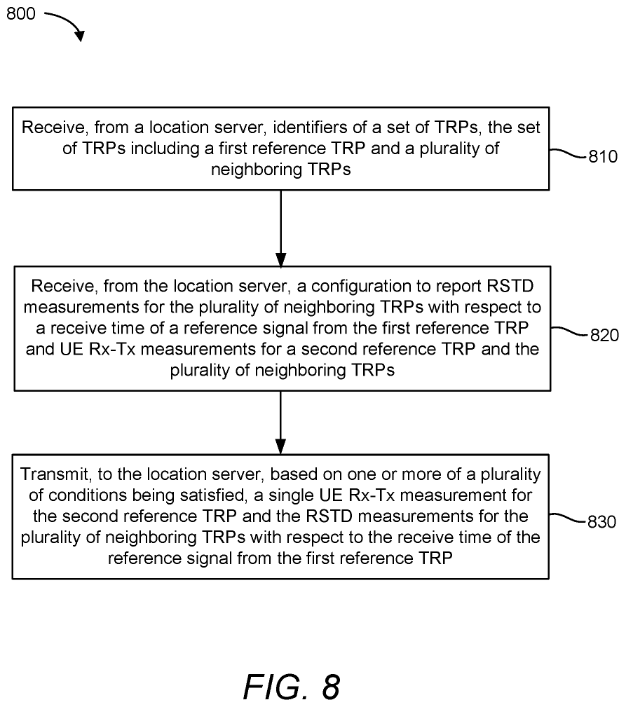

FIG. 8 illustrates an example method 800 of wireless communication, according to aspects of the disclosure. The method 800 may be performed by a UE (e.g., any of the UEs described herein).

At 810, the UE receives, from a location server (e.g., location server 230, LMF 270), identifiers of a set of TRPs, the set of TRPs including a first reference TRP and a plurality of neighboring TRPs. Operation 810 may be performed by WWAN transceiver 310, processing system 332, memory component 340, and/or positioning component 342, any or all of which may be considered means for performing this operation.

At 820, the UE receives, from the location server, a configuration to report RSTD measurements for the plurality of neighboring TRPs with respect to a receive time (e.g., ToA) of a reference signal from (transmitted by) the first reference TRP and UE Rx-Tx measurements for a second reference TRP and the plurality of neighboring TRPs. Operation 820 may be performed by WWAN transceiver 310, processing system 332, memory component 340, and/or positioning component 342, any or all of which may be considered means for performing this operation.

At 830, the UE transmits, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP. Operation 830 may be performed by WWAN transceiver 310, processing system 332, memory component 340, and/or positioning component 342, any or all of which may be considered means for performing this operation.

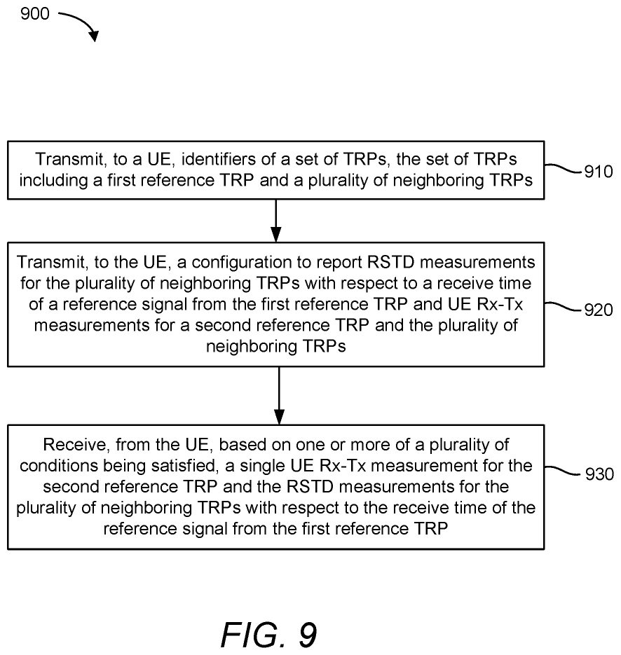

FIG. 9 illustrates an example method 900 of wireless communication, according to aspects of the disclosure. The method 900 may be performed by a location server (e.g., location server 230, LMF 270).

At 910, the location server transmits, to a UE (e.g., any of the UEs described herein), identifiers of a set of TRPs, the set of TRPs including a first reference TRP and a plurality of neighboring TRPs. Operation 910 may be performed by network interface(s) 390, processing system 394, memory component 396, and/or positioning component 398, any or all of which may be considered means for performing this operation.

At 920, the location server transmits, to the UE, a configuration to report RSTD measurements for the plurality of neighboring TRPs with respect to a receive time of a reference signal from the first reference TRP and UE Rx-Tx measurements for a second reference TRP and the plurality of neighboring TRPs. Operation 920 may be performed by network interface(s) 390, processing system 394, memory component 396, and/or positioning component 398, any or all of which may be considered means for performing this operation.

At 930, the location server receives, from the UE, based on one or more of a plurality of conditions being satisfied, a single UE Rx-Tx measurement for the second reference TRP and the RSTD measurements for the plurality of neighboring TRPs with respect to the receive time of the reference signal from the first reference TRP. Operation 930 may be performed by network interface(s) 390, processing system 394, memory component 396, and/or positioning component 398, any or all of which may be considered means for performing this operation.

In the detailed description above it can be seen that different features are grouped together in examples. This manner of disclosure should not be understood as an intention that the claimed examples have more features than are explicitly mentioned in each claim. Rather, the various aspects of the disclosure may include fewer than all features of an individual example disclosed. Therefore, the following claims should hereby be deemed to be incorporated in the description, wherein each claim by itself can stand as a separate example. Although each dependent claim can refer in the claims to a specific combination with one of the other claims, the aspect(s) of that dependent claim are not limited to the specific combination. It will be appreciated that other examples can also include a combination of the dependent claim aspect(s) with the subject matter of any other dependent claim or independent claim or a combination of any feature with other dependent and independent claims. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a claim can be included in any other independent claim, even if the claim is not directly dependent on the independent claim.

For example, further aspects may include one or more of the following features discussed in the various example aspects.

### EXAMPLE 1

A method of wireless communication performed by a UE, including receiving, from a location server, identifiers of a set of TRPs, the set of TRPs including a first reference TRP and a plurality of neighboring TRPs; receiving, from the location server, a configuration to report RSTD measurements for the plurality of neighboring TRPs with respect to a receive time of a reference signal from the first reference TRP and UE Rx-Tx measurements for a second reference TRP and the plurality of neighboring TRPs; and transmitting, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

### EXAMPLE 2

The method of example 1, wherein the second reference TRP comprises a serving TRP.

### EXAMPLE 3

The method of example 1, wherein the first reference TRP and the second reference TRP are different TRPs.

### EXAMPLE 4

The method of example 1, wherein the first reference TRP and the second reference TRP are the same TRP.

### EXAMPLE 5

The method of example 1, wherein one of the plurality of conditions comprises: the UE being configured to transmit one uplink reference signal resource towards the set of TRPs.

### EXAMPLE 6

The method of example 1, wherein one of the plurality of conditions comprises: the UE being configured to transmit on a plurality of uplink reference signal resources and the plurality of uplink reference signal resources having the same timing, the UE not being expected to perform an autonomous TA adjustment, and the UE not being expected to receive a TA command during one span of uplink reference signal transmission occasions.

### EXAMPLE 7

The method of example 1, wherein one of the plurality of conditions comprises: the UE being configured to transmit on a plurality of uplink reference signal resources, each of the plurality of uplink reference signal resources having the same reference as a spatial transmit reference resource or there being up to one spatial transmit reference resource configured across the plurality of uplink reference signal resources.

### EXAMPLE 8

The method of example 1, wherein one of the plurality of conditions comprises: the first reference TRP being a serving TRP.

### EXAMPLE 9

The method of example 1, wherein one of the plurality of conditions comprises: the UE being configured to report only the RSTD measurements for the plurality of neighboring TRPs.

### EXAMPLE 10

The method of example 1, wherein one of the plurality of conditions comprises: timestamps of the RSTD measurements for the plurality of neighboring TRPs being the same as timestamps of the UE Rx-Tx measurements for the plurality of neighboring TRPs, wherein the timestamps of the RSTD measurements for the plurality of neighboring TRPs comprise slots, subframes, and/or frames during which the RSTD measurements for the plurality of neighboring TRPs are valid.

### EXAMPLE 11

The method of example 1, wherein the at least one transceiver receives the configuration to report the RSTD measurements and the UE Rx-Tx measurements and transmits the single UE Rx-Tx measurement for the second reference TRP and the RSTD measurements for the plurality of neighboring TRPs during an LPP session.

### EXAMPLE 12

The method of example 1, wherein the UE is simultaneously involved in at least one RTT positioning session and an OTDOA positioning session.

### EXAMPLE 13

The method of example 1, wherein at least one condition of the plurality of conditions is associated with a threshold, and wherein, based on the at least one condition being below the threshold, an accuracy requirement of a location estimate of the UE is reduced.

### EXAMPLE 14

The method of example 1, wherein at least one condition of the plurality of conditions is associated with a range, and wherein, based on the at least one condition being outside of the range, an accuracy requirement of a location estimate of the UE is reduced.

### EXAMPLE 15

A method of wireless communication performed by a location server, including transmitting, to a UE, identifiers of a set of TRPs, the set of TRPs including a first reference TRP and a plurality of neighboring TRPs; transmitting, to the UE, a configuration to report RSTD measurements for the plurality of neighboring TRPs with respect to a receive time of a reference signal from the first reference TRP and UE Rx-Tx measurements for a second reference TRP and the plurality of neighboring TRPs; and receiving, from the UE, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

### EXAMPLE 16

The method of example 15, wherein the second reference TRP comprises a serving TRP.

### EXAMPLE 17

The method of example 15, wherein the first reference TRP and the second reference TRP are different TRPs.

### EXAMPLE 18

The method of example 15, wherein the first reference TRP and the second reference TRP are the same TRP.

### EXAMPLE 19

The method of example 15, wherein one of the plurality of conditions comprises: the UE being configured to transmit one uplink reference signal resource towards the set of TRPs.

### EXAMPLE 20

The method of example 15, wherein one of the plurality of conditions comprises: the UE being configured to transmit on a plurality of uplink reference signal resources and the plurality of uplink reference signal resources having the same timing, the UE not being expected to perform an autonomous TA adjustment, and the UE not being expected to receive a TA command during one span of uplink reference signal transmission occasions.

### EXAMPLE 21

The method of example 15, wherein one of the plurality of conditions comprises: the UE being configured to transmit on a plurality of uplink reference signal resources, each of the plurality of uplink reference signal resources having the same reference as a spatial transmit reference resource or there being up to one spatial transmit reference resource configured across the plurality of uplink reference signal resources.

### EXAMPLE 22

The method of example 15, wherein one of the plurality of conditions comprises: the first reference TRP being a serving TRP.

### EXAMPLE 23

The method of example 15, wherein one of the plurality of conditions comprises: the UE being configured to report only the RSTD measurements for the plurality of neighboring TRPs.

### EXAMPLE 24

The method of example 15, wherein one of the plurality of conditions comprises: timestamps of the RSTD measurements for the plurality of neighboring TRPs being the same as timestamps of the UE Rx-Tx measurements for the plurality of neighboring TRPs, wherein the timestamps of the RSTD measurements for the plurality of neighboring TRPs comprise slots, subframes, and/or frames during which the RSTD measurements for the plurality of neighboring TRPs are valid.

### EXAMPLE 25

The method of example 15, wherein the at least one network interface transmits the configuration to report the RSTD measurements and the UE Rx-Tx measurements and receives the single UE Rx-Tx measurement for the second reference TRP and the RSTD measurements for the plurality of neighboring TRPs during an LPP session.

### EXAMPLE 26

The method of example 15, wherein the UE is simultaneously involved in at least one RTT positioning session and an OTDOA positioning session.

### EXAMPLE 27

The method of example 15, wherein at least one condition of the plurality of conditions is associated with a threshold, and wherein, based on the at least one condition being below the threshold, an accuracy requirement of a location estimate of the UE is reduced.

### EXAMPLE 28

The method of example 15, wherein at least one condition of the plurality of conditions is associated with a range, and wherein, based on the at least one condition being outside of the range, an accuracy requirement of a location estimate of the UE is reduced.

### EXAMPLE 29

a UE including means for receiving, from a location server, identifiers of a set of TRPs, the set of TRPs including a first reference TRP and a plurality of neighboring TRPs; means for receiving, from the location server, a configuration to report RSTD measurements for the plurality of neighboring TRPs with respect to a receive time of a reference signal from the first reference TRP and UE Rx-Tx measurements for a second reference TRP and the plurality of neighboring TRPs; and means for transmitting, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

### EXAMPLE 30

The UE of example 29, wherein the second reference TRP comprises a serving TRP.

### EXAMPLE 31

The UE of example 29, wherein the first reference TRP and the second reference TRP are different TRPs.

### EXAMPLE 32

The UE of example 29, wherein the first reference TRP and the second reference TRP are the same TRP.

### EXAMPLE 33

The UE of example 29, wherein one of the plurality of conditions comprises: the UE being configured to transmit one uplink reference signal resource towards the set of TRPs.

### EXAMPLE 34

The UE of example 29, wherein one of the plurality of conditions comprises: the UE being configured to transmit on a plurality of uplink reference signal resources and the plurality of uplink reference signal resources having the same timing, the UE not being expected to perform an autonomous TA adjustment, and the UE not being expected to receive a TA command during one span of uplink reference signal transmission occasions.

### EXAMPLE 35

The UE of example 29, wherein one of the plurality of conditions comprises: the UE being configured to transmit on a plurality of uplink reference signal resources, each of the plurality of uplink reference signal resources having the same reference as a spatial transmit reference resource or there being up to one spatial transmit reference resource configured across the plurality of uplink reference signal resources.

### EXAMPLE 36

The UE of example 29, wherein one of the plurality of conditions comprises: the first reference TRP being a serving TRP.

### EXAMPLE 37

The UE of example 29, wherein one of the plurality of conditions comprises: the UE being configured to report only the RSTD measurements for the plurality of neighboring TRPs.

### EXAMPLE 38

The UE of example 29, wherein one of the plurality of conditions comprises: timestamps of the RSTD measurements for the plurality of neighboring TRPs being the same as timestamps of the UE Rx-Tx measurements for the plurality of neighboring TRPs, wherein the timestamps of the RSTD measurements for the plurality of neighboring TRPs comprise slots, subframes, and/or frames during which the RSTD measurements for the plurality of neighboring TRPs are valid.

### EXAMPLE 39

The UE of example 29, wherein the UE receives the configuration to report the RSTD measurements and the UE Rx-Tx measurements and transmits the single UE Rx-Tx measurement for the second reference TRP and the RSTD measurements for the plurality of neighboring TRPs during an LPP session.

### EXAMPLE 40

The UE of example 29, wherein the UE is simultaneously involved in at least one RTT positioning session and an OTDOA positioning session.

### EXAMPLE 41

The UE of example 29, wherein at least one condition of the plurality of conditions is associated with a threshold, and wherein, based on the at least one condition being below the threshold, an accuracy requirement of a location estimate of the UE is reduced.

### EXAMPLE 42

The UE of example 29, wherein at least one condition of the plurality of conditions is associated with a range, and wherein, based on the at least one condition being outside of the range, an accuracy requirement of a location estimate of the UE is reduced.

### EXAMPLE 43

a location server including means for transmitting, to a UE, identifiers of a set of TRPs, the set of TRPs including a first reference TRP and a plurality of neighboring TRPs; means for transmitting, to the UE, a configuration to report RSTD measurements for the plurality of neighboring TRPs with respect to a receive time of a reference signal from the first reference TRP and UE Rx-Tx measurements for a second reference TRP and the plurality of neighboring TRPs; and means for receiving, from the UE, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

### EXAMPLE 44

The location server of example 43, wherein the second reference TRP comprises a serving TRP.

### EXAMPLE 45

The location server of example 43, wherein the first reference TRP and the second reference TRP are different TRPs.

### EXAMPLE 46

The location server of example 43, wherein the first reference TRP and the second reference TRP are the same TRP.

### EXAMPLE 47

The location server of example 43, wherein one of the plurality of conditions comprises: the UE being configured to transmit one uplink reference signal resource towards the set of TRPs.

### EXAMPLE 48

The location server of example 43, wherein one of the plurality of conditions comprises: the UE being configured to transmit on a plurality of uplink reference signal resources and the plurality of uplink reference signal resources having the same timing, the UE not being expected to perform an autonomous TA adjustment, and the UE not being expected to receive a TA command during one span of uplink reference signal transmission occasions.

### EXAMPLE 49

The location server of example 43, wherein one of the plurality of conditions comprises: the UE being configured to transmit on a plurality of uplink reference signal resources, each of the plurality of uplink reference signal resources having the same reference as a spatial transmit reference resource or there being up to one spatial transmit reference resource configured across the plurality of uplink reference signal resources.

### EXAMPLE 50

The location server of example 43, wherein one of the plurality of conditions comprises: the first reference TRP being a serving TRP.

### EXAMPLE 51

The location server of example 43, wherein one of the plurality of conditions comprises: the UE being configured to report only the RSTD measurements for the plurality of neighboring TRPs.

### EXAMPLE 52

The location server of example 43, wherein one of the plurality of conditions comprises: timestamps of the RSTD measurements for the plurality of neighboring TRPs being the same as timestamps of the UE Rx-Tx measurements for the plurality of neighboring TRPs, wherein the timestamps of the RSTD measurements for the plurality of neighboring TRPs comprise slots, subframes, and/or frames during which the RSTD measurements for the plurality of neighboring TRPs are valid.

### EXAMPLE 53

The location server of example 43, wherein the at least one network interface transmits the configuration to report the RSTD measurements and the UE Rx-Tx measurements and receives the single UE Rx-Tx measurement for the second reference TRP and the RSTD measurements for the plurality of neighboring TRPs during an LPP session.

### EXAMPLE 54

The location server of example 43, wherein the UE is simultaneously involved in at least one RTT positioning session and an OTDOA positioning session.

### EXAMPLE 55

The location server of example 43, wherein at least one condition of the plurality of conditions is associated with a threshold, and wherein, based on the at least one condition being below the threshold, an accuracy requirement of a location estimate of the UE is reduced.

### EXAMPLE 56

The location server of example 43, wherein at least one condition of the plurality of conditions is associated with a range, and wherein, based on the at least one condition being outside of the range, an accuracy requirement of a location estimate of the UE is reduced.

### EXAMPLE 57

a non-transitory computer-readable medium including computer-executable instructions, the computer-executable instructions including at least one instruction instructing a UE to receive, from a location server, identifiers of a set of TRPs, the set of TRPs including a first reference TRP and a plurality of neighboring TRPs; at least one instruction instructing the UE to receive, from the location server, a configuration to report RSTD measurements for the plurality of neighboring TRPs with respect to a receive time of a reference signal from the first reference TRP and UE Rx-Tx measurements for a second reference TRP and the plurality of neighboring TRPs; and at least one instruction instructing the UE to transmit, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

### EXAMPLE 58

a non-transitory computer-readable medium including computer-executable instructions, the computer-executable instructions including at least one instruction instructing a location server to transmit, to a UE, identifiers of a set of TRPs, the set of TRPs including a first reference TRP and a plurality of neighboring TRPs; at least one instruction instructing the location server to transmit, to the UE, a configuration to report RSTD measurements for the plurality of neighboring TRPs with respect to a receive time of a reference signal from the first reference TRP and UE Rx-Tx measurements for a second reference TRP and the plurality of neighboring TRPs; and at least one instruction instructing the location server to receive, from the UE, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A user equipment (UE), comprising:
memory;
at least one transceiver; and
at least one processor communicatively coupled to the memory and the at least one transceiver, the at least one processor configured to:
receive, from a location server via the at least one transceiver, identifiers of a set of transmission-reception points (TRPs), the set of TRPs including a first reference TRP and a plurality of neighboring TRPs;
receive, from the location server via the at least one transceiver, a configuration to report reference signal time difference (RSTD) measurements for the plurality of neighboring TRPs with respect to a receive time of a reference signal from the first reference TRP and user equipment reception-to-transmission (UE Rx-Tx) measurements for a second reference TRP and the plurality of neighboring TRPs; and
cause the at least one transceiver to transmit, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

2. The UE of claim 1, wherein the second reference TRP comprises a serving TRP.

3. The UE of claim 1, wherein the first reference TRP and the second reference TRP are different TRPs.

4. The UE of claim 1, wherein the first reference TRP and the second reference TRP are the same TRP.

5. The UE of claim 1, wherein one of the plurality of conditions comprises:
the UE being configured to transmit one uplink reference signal resource towards the set of TRPs.

6. The UE of claim 1, wherein one of the plurality of conditions comprises:
the UE being configured to transmit on a plurality of uplink reference signal resources and the plurality of uplink reference signal resources having the same timing, the UE not being expected to perform an autonomous timing advance (TA) adjustment, and the UE not being expected to receive a TA command during one span of uplink reference signal transmission occasions.

7. The UE of claim 1, wherein one of the plurality of conditions comprises:
the UE being configured to transmit on a plurality of uplink reference signal resources, each of the plurality of uplink reference signal resources having the same reference as a spatial transmit reference resource or there being up to one spatial transmit reference resource configured across the plurality of uplink reference signal resources.

8. The UE of claim 1, wherein one of the plurality of conditions comprises:
the first reference TRP being a serving TRP.

9. The UE of claim 1, wherein one of the plurality of conditions comprises:
the UE being configured to report only the RSTD measurements for the plurality of neighboring TRPs.

10. The UE of claim 1, wherein one of the plurality of conditions comprises:
timestamps of the RSTD measurements for the plurality of neighboring TRPs being the same as timestamps of the UE Rx-Tx measurements for the plurality of neighboring TRPs, wherein the timestamps of the RSTD measurements for the plurality of neighboring TRPs comprise slots, subframes, and/or frames during which the RSTD measurements for the plurality of neighboring TRPs are valid.

11. The UE of claim 1, wherein the at least one transceiver receives the configuration to report the RSTD measurements and the UE Rx-Tx measurements and transmits the single UE Rx-Tx measurement for the second reference TRP and the RSTD measurements for the plurality of neighboring TRPs during a Long-Term Evolution (LTE) positioning protocol (LPP) session.

12. The UE of claim 1, wherein the UE is simultaneously involved in at least one round-trip-time (RTT) positioning session and an observed time difference of arrival (OTDOA) positioning session.

13. The UE of claim 1, wherein at least one condition of the plurality of conditions is associated with a threshold, and wherein, based on the at least one condition being below the threshold, an accuracy requirement of a location estimate of the UE is reduced.

14. The UE of claim 1, wherein at least one condition of the plurality of conditions is associated with a range, and wherein, based on the at least one condition being outside of the range, an accuracy requirement of a location estimate of the UE is reduced.

15. A location server, comprising:
a memory;
at least one network interface; and
at least one processor communicatively coupled to the memory and the at least one network interface, the at least one processor configured to:
cause the at least one network interface to transmit, to a user equipment (UE), identifiers of a set of transmission-reception points (TRPs), the set of TRPs including a first reference TRP and a plurality of neighboring TRPs;
cause the at least one network interface to transmit, to the UE, a configuration to report reference signal time difference (RSTD) measurements for the plurality of neighboring TRPs with respect to a receive time of a reference signal from the first reference TRP and UE reception-to-transmission (UE Rx-Tx) measurements for a second reference TRP and the plurality of neighboring TRPs; and
receive, from the UE via the at least one network interface, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

16. The location server of claim 15, wherein the second reference TRP comprises a serving TRP.

17. The location server of claim 15, wherein the first reference TRP and the second reference TRP are different TRPs.

18. The location server of claim 15, wherein the first reference TRP and the second reference TRP are the same TRP.

19. The location server of claim 15, wherein one of the plurality of conditions comprises:
the UE being configured to transmit one uplink reference signal resource towards the set of TRPs.

20. The location server of claim 15, wherein one of the plurality of conditions comprises:
the UE being configured to transmit on a plurality of uplink reference signal resources and the plurality of uplink reference signal resources having the same timing, the UE not being expected to perform an autonomous timing advance (TA) adjustment, and the UE not being expected to receive a TA command during one span of uplink reference signal transmission occasions.

21. The location server of claim 15, wherein one of the plurality of conditions comprises:
the UE being configured to transmit on a plurality of uplink reference signal resources, each of the plurality of uplink reference signal resources having the same reference as a spatial transmit reference resource or there being up to one spatial transmit reference resource configured across the plurality of uplink reference signal resources.

22. The location server of claim 15, wherein one of the plurality of conditions comprises:
the first reference TRP being a serving TRP.

23. The location server of claim 15, wherein one of the plurality of conditions comprises:
the UE being configured to report only the RSTD measurements for the plurality of neighboring TRPs.

24. The location server of claim 15, wherein one of the plurality of conditions comprises:
timestamps of the RSTD measurements for the plurality of neighboring TRPs being the same as timestamps of the UE Rx-Tx measurements for the plurality of neighboring TRPs, wherein the timestamps of the RSTD measurements for the plurality of neighboring TRPs comprise slots, subframes, and/or frames during which the RSTD measurements for the plurality of neighboring TRPs are valid.

25. The location server of claim 15, wherein the at least one network interface transmits the configuration to report the RSTD measurements and the UE Rx-Tx measurements and receives the single UE Rx-Tx measurement for the second reference TRP and the RSTD measurements for the plurality of neighboring TRPs during a Long-Term Evolution (LTE) positioning protocol (LPP) session.

26. The location server of claim 15, wherein the UE is simultaneously involved in at least one round-trip-time (RTT) positioning session and an observed time difference of arrival (OTDOA) positioning session.

27. The location server of claim 15, wherein at least one condition of the plurality of conditions is associated with a threshold, and wherein, based on the at least one condition being below the threshold, an accuracy requirement of a location estimate of the UE is reduced.

28. The location server of claim 15, wherein at least one condition of the plurality of conditions is associated with a range, and wherein, based on the at least one condition being outside of the range, an accuracy requirement of a location estimate of the UE is reduced.

29. A method of wireless communication performed by a user equipment (UE), comprising:
receiving, from a location server, identifiers of a set of transmission-reception points (TRPs), the set of TRPs including a first reference TRP and a plurality of neighboring TRPs;
receiving, from the location server, a configuration to report reference signal time difference (RSTD) measurements for the plurality of neighboring TRPs with respect to a receive time of a reference signal from the first reference TRP and UE reception-to-transmission (UE Rx-Tx) measurements for a second reference TRP and the plurality of neighboring TRPs; and
transmitting, to the location server, based on one or more of a plurality of conditions being satisfied, a single UE Rx-Tx measurement for the second reference TRP and the RSTD measurements for the plurality of neighboring TRPs with respect to the receive time of the reference signal from the first reference TRP.

30. A method of wireless communication performed by a location server, comprising:
transmitting, to a user equipment (UE), identifiers of a set of transmission-reception points (TRPs), the set of TRPs including a first reference TRP and a plurality of neighboring TRPs;
transmitting, to the UE, a configuration to report reference signal time difference (RSTD) measurements for the plurality of neighboring TRPs with respect to a receive time of a reference signal from the first reference TRP and user equipment reception-to-transmission (UE Rx-Tx) measurements for a second reference TRP and the plurality of neighboring TRPs; and
receiving, from the UE, based on one or more of a plurality of conditions being satisfied, a single UE Rx-Tx measurement for the second reference TRP and the RSTD measurements for the plurality of neighboring TRPs with respect to the receive time of the reference signal from the first reference TRP.
